(19) United States
(12) Patent Application Publication
(10) Pub. No.: US 2026/0225895 A1
(43) Pub. Date: Aug. 6, 2026

(54) CARBON PARTICLES AND METHOD FOR THEIR MANUFACTURE

(71) Applicant: ExxonMobil Advanced Graphite Solutions LLC, Spring, TX (US)

(72) Inventors: Sören Köster, Montabaur (DE); François Henry, Oak Park, IL (US)

(73) Assignee: ExxonMobil Advanced Graphite Solutions LLC, Spring, TX (US)

(21) Appl. No.: 19/570,940

(22) Filed: Mar. 18, 2026

Related U.S. Application Data
(63) Continuation of application No. 19/111,341, filed on Sep. 15, 2023.
(60) Provisional application No. 63/406,932, filed on Sep. 15, 2022.

(51) Int. Cl. C01B 32/205; C01B 32/21; H01M 4/587; H01M 10/0525

(52) U.S. Cl. CPC C01B 32/205; C01B 32/21; H01M 4/587; H01M 10/0525; C01P 2002/77; C01P 2002/85; C01P 2004/61; C01P 2004/84; C01P 2006/12; C01P 2006/40; C01P 2006/80

(57) ABSTRACT

The invention relates to a carbon particle comprising at least 97 wt. % carbon, based on the total weight of the carbon particle, at most 0.2 wt. % impurities, based on the total weight of the carbon particle, at least 0.08 wt. % boron, based on the total weight of the carbon particle, at most 0.05 wt. % boron carbide, based on the total weight of the carbon particle. The invention also relates to a method for the manufacture of the carbon particle comprising a graphitization step in an electric field. The invention also relates to the use of the carbon particle as the active material of a negative electrode for a battery.

### CROSS REFERENCE TO RELATED APPLICATION

This application is a continuation of U.S. application Ser. No. 19/111,341 filed Jan. 9, 2026 which is a 35 U.S.C. 371 national phase entry of PCT/US2023/032919 filed Sep. 15, 2023 which claims priority to U.S. Provisional Application No. 63/406,932 filed Sep. 15, 2022, the disclosures of which is hereby incorporated by reference in their entirety.

### BACKGROUND OF THE INVENTION

The invention relates to a carbon particle, a method for its preparation and its use as active material of a negative electrode for a battery.

Carbonaceous materials can store and yield lithium ions electrochemically, and have thus been studied as active materials for negative electrodes in lithium-ion batteries, with these electrodes often referred to as anodes, in accordance with their role during battery discharge.

Especially, it has been found that graphite, a crystalline, layered allotrope of carbon, provides both a high specific capacity and a low discharge potential, close to that of lithium metal, thus enabling batteries of high energy density. Moreover, these graphitic anode materials have been developed in various forms that make lithium-ion batteries commercially viable in terms of safety, shelf life and charge-discharge cycle longevity. Therefore, today graphite is the most prominent active material for lithium-ion secondary batteries.

The distance between two adjacent layers in graphite is described by the doo2 value obtained from powder X-Ray diffraction measurements. The doo2 value is often referred to as the interlayer distance. A lower doo2 value is usually associated with higher specific capacity. We use Bragg's law in the form:

$$2 * {d}_{hkl} * sin ( {Theta}_{n} ) = n * lambda$$

Where we have:
   dₕₖ₁=interplanar distance
   lambda=wavelength X-ray
   n=order of reflection
   Thetaₙ=Bragg's angle for the nth order reflection

For graphite, the hexagonal variety is the dominant stacking variant, for which we have

$$l / {d}_{hkl}^{2} = ( 4 / 3 * ( {h}^{2} + {k}^{2} + h * k ) + {l}^{2} * {( a / c )}^{2} ) * 1 / {a}^{2}$$

In this, c=2*d₀₀₂, and a is the length of a diagonal in the constitutional hexagon in the graphene layer, for which we have a=2*d₁₁₀.

Impurities, especially sulfur and oxygen, in graphite and in the respective precursor material often have a negative influence on the specific capacity that can be obtained with a given graphite sample. Also, the particle size and the particle shape can impact the specific capacity that can be obtained with a given graphite sample, with the primary aspect affected by the typical particle size being the rate capability of the anode.

In order to meet the requirements for a high specific capacity in battery applications, natural graphite has to be shaped, sized and purified. Synthetic graphite that is normally produced from coke in a process referred to as graphitization, has also been used as the active material for negative electrodes. The graphitization, in which the previously amorphous carbon at least partially crystallizes and some of the impurities may be removed, is normally carried out under the exclusion of oxidizing atmosphere at high temperatures, exceeding 1700° C. and preferably exceeding 2500° C., with the high temperatures usually obtained from resistive heating by passing a large current through the carbonaceous material. Graphitization is held to be effected by the exposure to temperature over time, whereas at lower temperatures the time required to achieve sufficient graphiticity becomes prohibitive for any commercially viable process.

Historically, the so-called Acheson process is applied, which requires batchwise processing and large amounts of energy. Drawbacks of the Acheson process include long cooldown times, inhomogeneous product properties, limited control of the atmosphere, limited purification effect and large amounts of by-products. These disadvantages force very high treatment temperatures over extended periods of time.

The first charging of a lithium-ion secondary battery is normally called “formation”. During formation of a lithium-ion secondary batter containing an anode with graphite as the active material, the non-aqueous solvent or additives within the electrolyte are reduced at the surface of the graphite and decomposes, thus forming a solid-electrolyte interface, the so called SEI (solid electrolyte interface) layer. This process consumes not only organic molecules, but also lithium ions, which are irreversibly lost to the formation of various lithium salts in the SEI layer.

The stability of the SEI layer itself and the surface (and resultingly of the bulk) of the graphitic particle itself over many charge-discharge cycles and during storage are among the decisive properties for the commercial value of the battery system.

In order to reduce the extent of lithium loss in the first cycle and stabilize the SEI layer over many cycles, the graphite particles making up the anode may be modified, such as by controlling the chemical surface activity. It has proven beneficial to coat the particles with a more inert layer before exposure to an electrolyte, where the application of this coating, its post-treatment and finishing (often by a secondary heat treatment at lower temperatures or an additional secondary coating through CVD or other technology) has to be carefully carried out to successfully integrate the particles into the overall battery system.

In the search for a material unifying solutions to the many demands of the lithium ion battery in reliable, simple, and cost effective ways, multiple approaches have been taken. One very interesting concept is that of doping the carbon with its natural alloying partners, namely boron and nitrogen. The solutions presented in the literature so far, however, have been limited in their success.

Among the challenges of this approach are the distribution of the alloying element source, which is often in the coke precursor, thus having the effect of an impurity on the graphitization potential, similar for example to that of sulfur, or by a separate powder, which can negatively affect the graphite particle integrity. Slow heat up and cool down rates can lead to the formation of undesirable structures, as outlined below.

An example of coated carbon particles is described in U.S. Pat. No. 6,869,546 B1, describing a carbon material comprising a first carbon material serving as an inner core particle having an outer surface, and a coating of a second carbon material on said outer surface of the first carbon material, the second carbon material containing at least 1 wt. % to up to 15 wt. % of boron.

Boron and nitrogen can partially substitute carbon in a graphite structure. Boron and nitrogen can be found in natural graphite (not necessarily in substitutional positions in the graphite layer) and are sometimes intentionally added in the preparation of synthetic graphite, as boron reportedly accelerates the crystallization of carbon to graphite during high temperature treatment allowing for lower process temperatures.

Synthetic graphitic carbon materials comprising boron and/or nitrogen have been reported.

For example, U.S. Pat. No. 5,358,805A describes a secondary battery comprising a positive electrode, an electrolyte, a negative electrode which is capable of intercalating lithium reversibly; wherein said negative electrode comprises a carbon compound having a crystal structure of graphite in which carbon (C) is partially replaced by both boron (B) and nitrogen (N), said carbon compound having the formula BC₃N.

In particular, it was hypothesized that placing boron and/or nitrogen on the surface of carbon particles improves the surface chemistry of the carbon particles. Adding boron and nitrogen during graphitization can be targeted to integrate named elements in the carbon surface, thus improving the formation and stabilizing the SEI layer. However, this may lead to the formation of a boron nitride surface coating in addition to a boron and nitrogen doping. A boron nitride coating may increase the chemical stability of graphite, yet due to its insulating nature, this negatively affects the diffusion of the lithium ions and the interaction between SEI layer, the electrolyte and the surface of the anode particle. Controlling and adjusting the amount of boron nitride is therefore of high interest. In this respect, US 2018/0337423 A1 describes a negative-electrode active material comprising a graphite including boron and nitrogen and describes that X-Ray photoelectron spectroscopy (XPS) may be used to observe the ratio between boron bonded to nitrogen peak area and total boron peak area, each considering the boron Is spectrum.

Moreover, J P 2000 012020 A describes a negative electrode material for a lithium secondary battery, which is graphitized carbon powder containing boron and nitrogen, wherein the 10% cumulative diameter (d₁₀) of the carbonaceous powder is 5 to 25 μm.

JP 2000 12021 A describes a negative electrode material for a lithium secondary battery, comprising graphitized carbon powder containing boron and nitrogen, wherein the specific surface area calculated by desorption of nitrogen to the carbon powder is 10 m²/g or less.

A surface treatment after graphitization is described in US 2001/0051300 A1, resulting in a graphite powder containing 0.01 to 5.0 wt % of boron and having a looped closure structure at an end of a graphite c-planar layer on the surface of a powder, with the density of the interstitial planar sections between neighboring closure structures being not less than 100/μm and not more than 1500/μm.

Similar to boron nitride, boron carbide may form in the graphitization process, but is not restricted to the surface of the particles. Boron carbide is disadvantageous in that it may act as an abrasive when coating particles containing boron carbide onto other surfaces such as metal foils. Further, boron carbide is substantially unreactive and thus decreases the gravimetric and volumetric capacity of the particles.

In view of the prior art, an object of the present invention is to provide carbon particles, that can be used in anodes for lithium-ion batteries. The carbon particles should in particular result in anodes and/or batteries with high shelf life and/or high specific capacity and/or high cycle life. A further object of the invention is to provide a method for the manufacture of such carbon particles. The method in particular should allow to prepare particles with tailored properties, preferably excluding or at least limiting the tradeoffs of the doping with boron and nitrogen known from other approaches.

Other and further objects, features and advantages of the present invention will become apparent more fully from the following description.

### SUMMARY OF THE INVENTION

Some or all of the objects above are solved by the carbon particle according to claim 1, the method according to claim 12, the use according to claim 19, and the battery according to claim 20.

Without wishing to be bound by scientific theory, it is believed that impurities in the carbon particles can affect electrochemical properties and graphite crystallinity, thus their removal during the graphitization process can be advantageous. Moreover, impurities of metallic nature in particular carry the risk of facilitating side reactions in the chemical battery system, thus posing a risk to the control of the battery, its shelf and cycle life.

Boron on the other hand can be beneficial in regard to these properties, yet the formation of boron carbide clusters is believed to render boron inactive, and macroscopic crystals are known to be abrasive, and boron carbide formation should therefore be suppressed. It was surprisingly found that the granulation of carbonaceous particles by an organic binder and subsequent carbonization and lastly, graphitization in an electric field, in particular an electro-thermal fluidized bed, followed by deagglomeration of the granules, in particular by mild mechanical decomposition of the granules to reclaim the particles, may allow for the use of a wide range of precursor particle sizes and results in particles with a graphitized core and an unstructured carbon shell. In this way, numerous advantages of the doping with boron and nitrogen may be unified while its potential trade-offs known from other approaches may be avoided or at least limited. The process may allow for controlled introduction of boron and nitrogen as dopants to particle bulk and surface, and presumably limit formation of boron carbide and boron nitride. The carbon particles according to the invention can be used in Lithium-ion secondary batteries, specifically in their anodes as negative electrode active material. The resulting batteries may in particular show high shelf-life and/or high specific capacity and/or high cycle life. Without wishing to be bound by scientific theory, it is believed that the carbon particles contain the boron only in a very low amount of clusters, helping in achieving the anodes and/or batteries with desirable characteristics.

### BRIEF DESCRIPTION OF THE DRAWINGS

FIG. 1 shows a graph showing the connection between boron substitution and graphiticity.

FIG. 2 shows a part of an XPS spectrum of a natural flake graphite purified and boronated in an electrothermal fluidized bed reactor in nitrogen atmosphere in the presence of a boron source at a black body radiation temperature of about 2300° C. and a residence time as for Examples 1-6 described below. The boron nitride was removed from the surface mechanically using a tape.

FIG. 3 shows particle size distributions of several particles.

### DETAILED DESCRIPTION OF THE INVENTION

Embodiments of the present disclosure will be described in detail below. However, the present disclosure is not limited to these embodiments.

According to an embodiment, the carbon particle has a BET surface area of from 0.5 to 50 m²/g, preferably from 0.5 to 10 m²/g, more preferably from 1 to 3 m²/g, even more preferably from 1 to 2 m²/g. The BET surface area is preferably determined by nitrogen adsorption desorption methods. Optimized specific surface areas are important for graphite as active material in anodes for lithium-ion batteries, as a higher specific surface area can be connected with higher irreversible lithium loss during SEI formation, while a lower specific surface area can be connected with in low conductivity and rate capability of the anode. Carbon particles with the BET surface areas mentioned herein may in particular have a good balance between lithium loss and conductivity.

According to another embodiment, the carbon particle has a d₀₀₂ spacing of from 0.3363 nm to 0.3355 nm, preferably from 0.3359 nm to 0.3355 nm, and/or a duo spacing of from 0.120 nm to 0.126 nm, preferably from 0.1229 nm to 0.1236 nm, more preferably from 0.123027 nm to 0.123244 nm. A lower d₀₀₂ can be associated with higher specific capacity, and can be a measure for the degree of graphitization and crystallinity of the carbon. The d₁₁₀ spacing is affected by boron doping, wherein a duo spacing in the specified range can indicate homogeneous distribution of boron atoms in the graphite structure, as opposed to the formation of clusters with higher boron content.

According to an embodiment, an XPS spectrum of the carbon particle has a first peak at from 184.0 eV to 188.0 eV, preferably from 185.0 eV to 187.5 eV, more preferably from 185.5 eV to 187.0 eV, most preferably at about 186.5 eV and/or a second peak at from 188.5 eV to 192.0 eV, preferably from 189.0 eV to 191.5 eV, more preferably from 189.5 eV to 191.0 eV, most preferably at about 190.3 eV, and/or substantially no peak at about 187.7 eV. Preferably, the intensity ratio in the XPS spectrum of the first peak to the second peak is from 0.25 to 6.0, preferably from 0.5 to 2, more preferably from 0.8 to 1.25. A high intensity ratio of the first to the second peak indicates a strong presence of B-N bonds, which usually is connected with the presence of boron nitride. The first peak and/or the second peak are preferably significant in the XPS spectrum. The first peak in the XPS spectrum is preferably a Bls peak indicating the presence of boron-carbon bonds on the surface of the carbon particle. The first peak in the XPS spectrum may also be referred to as Bls (BC) peak. The second peak in the XPS spectrum is preferably a Bls peak indicating boron-nitrogen bonds on the surface of the carbon particle. The second peak in the XPS spectrum may also be referred to as B1s (BN) peak. The peak at 187.7 eVis preferably a Bls peak indicating boron-boron bonds and/or boron-boron clusters. Preferably, the peak at 187.7 eV is below the detection limit.

In the XPS spectrum, to establish the presence of nitrogen in the hard carbon shell itself, the boron nitride is removed through a mild treatment with caustic NaOH_{aq} (10% NaOH 20 min at 250° C. in Anton Paar Multiwave 7000 Microwave digester using PTFE sample vessel, followed by neutralization with nitric acid). The remaining B-N peak at around 190.3 eV indicates doped nitrogen in the shell of the carbon particles, which improves the surface properties of the particle.

According to yet another embodiment, the carbon particle contains at least 97.5 wt. %, preferably at least 98 wt. %, more preferably at least 98.5 wt. % carbon, based on the total weight of the particle. A higher carbon content can indicate a higher share of active material able to intercalate lithium in anodes fabricated from it, which may result in higher specific capacity. Also, a higher carbon content can indicate a lower content of impurities that can have various detrimental effects.

According to a preferred embodiment, at least 85 wt. %, more preferable at least 90 wt. %, most preferably at least 95 wt. % of the carbon contained in the carbon particle is graphitic carbon.

‘Impurities’ herein preferably mean constitutional elements in the particle other than carbon, boron and nitrogen. Impurities can affect graphite properties, especially regarding the crystallinity and layering of graphite. Moreover, impurities of metallic nature in particular can carry the risk of facilitating side reactions in the chemical battery system, thus posing a risk to the control of the battery, its shelf and cycle life. The initially found impurities can depend on the source and previous processing of the carbonaceous material precursor. Preferably, the carbon particles disclosed herein contain a low amount of impurities. According to an embodiment, the carbon particle contains at most 0.1 wt. %, preferably at most 0.05 wt. %, more preferably at most 0.04 wt. %, even more preferably at most 0.03 wt. %, most preferably at most 0.025 wt. % impurities, based on the total weight of the carbon particle.

According to yet another embodiment, the impurities are at least one of impurities of metallic nature, such as transition metals, in particular vanadium and/or iron, oxygen and sulfur, preferably at least one of transition metals, in particular vanadium and/or iron, oxygen and sulfur. Preferably, the carbon particles contain at most 100 ppm oxygen and 100 ppm sulfur. The levels of oxygen as well as the total nitrogen content were determined using a Leco ONH836 gas analyzer, the levels of sulfur a LECO SC-432 sulfur determination unit, vanadium, iron and other elements, in particular metals, using a Jobin Yvon Horiba Ultima 2 1CP-OES after nitric-sulfuric acid digestion (for vanadium and other metals) and a hydrochloric digestion (iron), respectively.

According to yet another embodiment the carbon particle contains at most 0.03 wt. %, preferably at most 0.02 wt. %, more preferably at most 0.01 wt. %, most preferably at most 0.005 wt. % boron carbide, based on the total weight of the carbon particle, and/or wherein the carbon particle contains at most 0.5 wt. % boron nitride, preferably, at most 0.3 wt. % boron nitride, more preferably at most 0.1 wt. % boron nitride, based on the total weight of the carbon particle. The carbon particle may also contain boron nitride, in particular in an amount from 0.05 wt. % to 1 wt. %, preferably from 0.1 wt. % to 0.8 wt. %, based on the total weight of the carbon particle. The boron nitride, if it is present, is preferably located on the surface of the carbon particle. It has been found that with boron and/or nitrogen contained in the carbon particles in amounts within the ranges described above, the formation of dopant-rich clusters and/or phases and/or particles and/or surfaces may be reduced. Dopant-rich clusters and/or phases and/or particles and/or surfaces may reduce the ability of the carbon particle to intercalate and de-intercalate lithium, or may even contribute to irreversible loss of lithium in side reactions. Further, boron carbide may act as an abrasive when coating a slurry containing the carbon particles on a copper foil for making a negative electrode for a battery. In addition, boron carbide is essentially unreactive thereby reducing the gravimetric and volumetric capacity of a negative electrode.

Boron may be present in the carbon particles in different forms. For example, boron may be present in the form of boron nitride. Boron nitride is preferably located at the surface of the carbon particles. Boron may also be present in the form of boron carbide.

Boron nitride can be removed by treating the carbon particle by leaching with caustic (NaOH_{aq}) up to 250° C. in a Anton Paar Multiwave 7000 Microwave digester. The residue of the caustic treatment can be used as a way to quantify the boron nitride using ICP-OES on the boron. The upper limit of the amount of boron carbide can be determined as follows: during the XRD measurement for graphiticity, the diffractogram may be checked for boron carbide reflexes. The ash of samples of the carbon particles (3 g sample, 780-800° C. in Muffle furnace for 8 hours, air) may then be visually inspected for boron carbide particles. The ash is of a white color, boron nitride stands out as white particles and boron carbide would stand out as grey to black specs in the ash. The upper limit of boron carbide in the carbon particles may then be determined by comparing the amount of grey to black specs of boron carbide in the ash compared with the white particles of the boron nitride, wherein the amount of boron nitride may be determined using 1CP-OES as described herein. Also, an XRD analysis may be done on the ash as additional control.

Moreover, boron may also be present instead of a carbon atom. For example, if the carbon particle contains a graphene sheet or a graphite crystallite, or amorphous carbon structures, a boron atom may be located at a lattice position in the graphene sheet or in the graphite crystallite replacing the carbon atom at this lattice position, or the boron atom may replace a carbon atom in the amorphous carbon structure. In this case, the boron is also said to be in a substitutional position. The amount of boron in a substitutional position in the carbon particles can in particular be determined by the following steps: firstly ashing 3 g of sample in a Muffle furnace at 780-800° C. for eight hours in air, secondly, leaching the boron oxide from the ash in hot 2% nitric acid followed by the filtration of boron nitride in the ash to obtain a nitric acid filtrate, thirdly, determining the boron content in the nitric acid filtrate using ICP-OES.

The carbon particle comprises at least 0.08 wt. % boron, based on the total weight of the carbon particle. According to an embodiment, the carbon particle contains at least 0.1 wt. %, preferably at least 0.15 wt. %, more preferably at least 0.2 wt. %, even more preferably at least 0.3 wt. % boron, based on the total weight of the carbon particle, and/or at most 2.3 wt. %, preferably at most 2 wt. %, more preferably at most 1.5 wt. %, most preferably at most 1.3 wt. %, based on the total weight of the carbon particle. According to a preferred embodiment, the carbon particle contains from 0.1 wt. % to 2 wt. %, more preferably from 0.3 wt. % to 1.5 wt. % boron. The aforementioned boron contents in the carbon particle are preferably for boron in a substitutional position in the carbon particle. A carbon particle with a boron content in the ranges described herein, in particular with such a boron content in a substitutional position, can suppress the formation of by-products not involved in intercalation or deintercalation of lithium ions and may retain a high specific discharge capacity.

According to one embodiment, the carbon particle contains both boron nitride and boron, preferably in a weight ratio of at least 0.0005 wt percent points boron nitride per wt. percent point boron to at most 2.5 wt percent points boron nitride per wt. percent point boron, more preferably in a weight ratio of at least 0.001 wt percent points boron nitride per wt. percent point boron to at most 1 wt percent points boron nitride per wt. percent point boron, even more preferably in a weight ratio of at least 0.002 wt percent points boron nitride per wt. percent point boron to at most 0.1 wt percent points boron nitride per wt. percent point boron.

According to one embodiment, the carbon particle contains both boron nitride and boron, preferably in a weight ratio of at least 0.02 (wt. % boron nitride/wt. % boron) to at most 12.5 (wt. % boron nitride/wt. % boron), more preferably in a weight ratio of at least 0.05 (wt. % boron nitride/wt. % boron) to at most 1 (wt. % boron nitride/wt. % boron), even more preferably in a weight ratio of at least 0.07 (wt. % boron nitride/wt. % boron) to at most 0.3 (wt. % boron nitride/wt. % boron).

According to yet another embodiment, the carbon particle contains nitrogen. Advantageously, the carbon particle contains nitrogen in particular in an amount of at least 0.005 wt. %, preferably from 0.01 to 0.05 wt. %, more preferably from 0.015 to 0.04 wt. %, most preferably from 0.02 to 0.03 wt. %, based on the total weight of the carbon particle. The aforementioned amount of nitrogen in the carbon particle is preferably determined after the boron nitride was removed from the surface of the carbon particle. Nitrogen doping in the ranges described herein can help in reducing formation of byproducts not involved in intercalation or deintercalation of lithium ions and retention of a high specific discharge capacity. The nitrogen after removal of the boron nitride in the carbon particle may be determined by XPS after removal of the boron nitride. According to a preferred embodiment, the carbon particle contains boron and nitrogen. Advantageously, the carbon particle comprises at least 97 wt. % carbon, based on the total weight of the carbon particle, at most 0.2 wt. % impurities, based on the total weight of the carbon particle, at least 0.08 wt. % boron, based on the total weight of the carbon particle, at most 0.05 wt. % boron carbide, based on the total weight of the carbon particle, and nitrogen.

The boron is preferably in a substitutional position in the carbon particle.

According to another preferred embodiment, the carbon particle comprises at least 97 wt. % carbon, based on the total weight of the carbon particle, at most 0.2 wt. % impurities, based on the total weight of the carbon particle, at least 0.15 wt. % boron, based on the total weight of the carbon particle, at most 0.05 wt. % boron carbide, based on the total weight of the carbon particle The boron is preferably in a substitutional position in the carbon particle.

According to another preferred embodiment, the carbon particle comprises at least 97 wt. % carbon, based on the total weight of the carbon particle, at most 0.2 wt. % impurities, based on the total weight of the carbon particle, at least 0.15 wt. % boron, based on the total weight of the carbon particle, at most 0.05 wt. % boron carbide, based on the total weight of the carbon particle, and nitrogen.

According to another preferred embodiment, the carbon particle comprises at least 97 wt. % carbon, based on the total weight of the carbon particle, at most 0.2 wt. % impurities, based on the total weight of the carbon particle, at least 0.15 wt. % boron, based on the total weight of the carbon particle, at most 0.05 wt. % boron carbide, based on the total weight of the carbon particle, and at least 0.0003% nitrogen and at most 1% nitrogen.

According to another preferred embodiment, the carbon particle comprises at least 97 wt. % carbon, based on the total weight of the carbon particle, at most 0.2 wt. % impurities, based on the total weight of the carbon particle, at least 0.15 wt. % boron, based on the total weight of the carbon particle, at least 0.0001 and at most 0.05 wt. % boron carbide, based on the total weight of the carbon particle, and nitrogen, and the carbon particle is preferably a core-shell particle, in particular with a hard-carbon shell.

According to another preferred embodiment, the carbon particle comprises at least 97 wt. % carbon, based on the total weight of the carbon particle, at most 0.2 wt. % impurities, based on the total weight of the carbon particle, at least 0.08 wt. % boron, based on the total weight of the carbon particle, at most 0.05 wt. % boron carbide, based on the total weight of the carbon particle, nitrogen, and boron nitride, wherein boron nitride and boron are contained in a weight ratio of at least 0.0005 wt percent points boron nitride per wt. percent points boron to 2.5 wt percent points boron nitride per wt percent point boron.

According to another preferred embodiment, the carbon particle comprises at least 97 wt. % carbon, based on the total weight of the carbon particle, at most 0.2 wt. % impurities, based on the total weight of the carbon particle, at least 0.08 wt. % boron, based on the total weight of the carbon particle, at most 0.05 wt. % boron carbide, based on the total weight of the carbon particle, nitrogen, and boron nitride, and has a boron nitride/boron weight ratio of at least 0.02 (wt. % boron nitride/wt. % boron) to at most 12.5 (wt. % boron nitride/wt. % boron).

According to yet another embodiment, the carbon particle has a particle size distribution d₅₀ from 3 to 30 μm, preferably from 4 to 25 μm, more preferably from 5 to 20 μm. Advantageously, the carbon particles have a particle size distribution d₁₀ from 1 to 25 μm, preferably from 1.5 to 20 μm, more preferably from 2 to 15 μm. Advantageously, the carbon particles have a particle size distribution d₉₀ from 6 to 50 μm, preferably from 8 to 45 μm, more preferably from 10 to 35 μm.

While particles that are smaller than specified above may irreversibly consume excess lithium due to SEI formation and may show reduced specific capacities, particles larger than above may suffer from slow lithium intercalation and deintercalation, resulting in low anode rate capability. Particles outside the specified size distribution may also negatively impact the anode fabrication process, and result in anodes of poor manufacturing quality.

All particle size distributions described herein are preferably volumetric, determined by wet dispersed laser diffraction using a Microtrac S3500 after dispersing under sonication in a Branson 3510 ultrasound bath using a Branson Sonifier 250-Ultrasonic Probe with a surfactant ‘Triton X100’.

According to yet another embodiment, the carbon particle is a core-shell particle comprising a substantially non-graphitizable, in particular hard carbon, shell, and a carbon core that is at least partially graphitized and may still contain graphitizable, in particular soft carbon, parts. Without wishing to be bound by scientific theory, it is believed that a shell of hard carbon reduces the irreversible loss of lithium to the SEI formation and/or side reactions and/or may protect the inner surface of the particle core from similar side reactions, and in particular of the co-intercalation of electrolyte which would result in a degradation of the particle. At the same time, it is believed that the shell is conductive to lithium ions so as not to affect the lithium storage properties of the core.

For core-shell particles, the core advantageously comprises from 91 wt. % to 99 wt. %, preferably from 92 wt. % to 99 wt. %, more preferably from 94 wt. % to 98.5 wt. %, of the total weight of the carbon particle, and the shell comprises from 1 wt. % to 9 wt. %, preferably from 1 wt. % to 8 wt. %, more preferably from 1.5 wt. % to 6 wt. %, of the total weight of the carbon particle.

The shell is preferably formed from carbonized binder.

Another aspect of the present disclosure relates to a method for the preparation of the carbon particles disclosed herein, wherein in a granulation step, carbonaceous particles are granulated using a binder to yield carbonaceous granules, in a carbonization step, the carbonaceous granules are heated to a temperature of at least 1000° C. to yield carbonized granules, in a graphitization step, the carbonized granules are introduced into an electrical field to effect the graphitization of the carbonized granules thereby yielding graphitized granules, and in a deagglomeration step, the graphitized granules are deagglomerated, thereby yielding the carbon particles, wherein at least one of the granulation step, the carbonization step, and the graphitization step are conducted in the presence of a boron source.

After the graphitization step, the graphitized granules preferably contain the carbon particles that adhere to each other. In the deagglomeration step, the particle-particle contacts of the carbon particles in the graphitized granule are preferably crushed to deagglomerate the graphitized granules. Advantageously, the carbon particles themselves are substantially not crushed into smaller carbon particles. The deagglomeration of the graphitized granules is preferably substantially achieved by shearing forces. The deagglomeration step may be referred to as a mechanical disintegration step.

In an embodiment, the carbonaceous particles have a particle size distribution d₅₀ from 3 to 30 μm, preferably from 4 to 25 μm, more preferably from 5 to 20 μm. Advantageously, the carbonaceous particles have a particle size distribution d₁₀ from 1 to 25 μm, preferably from 1.5 to 20 μm, more preferably from 2 to 15 μm. Advantageously, the carbonaceous particles have a particle size distribution d₉₀ from 6 to 50 μm, preferably from 8 to 45 μm, more preferably from 10 to 35 μm.

Preferably, the carbonaceous particles are selected from green petcoke particles, calcined petcoke particles, spherical flake graphite particles, spherical natural graphite particles, recycled anode powder particles, petroleum coke, pitch coke, carbonized wood, needle coke, sponge coke, shot coke, metallurgical coke, coal tar based carbons, mesocarbons, anthracite, synthetic graphite, natural graphite, expanded graphite, carbonized polymers, carbon black, and mixtures thereof, preferably selected from green petcoke particles, calcined petcoke particles, spherical flake graphite particles, spherical natural graphite particles, recycled anode powder particles, and mixtures thereof. The method can allow for a wide range of precursor particle sizes as granules of particles and binder are formed in the granulation step, which may result in particles with a correct size distribution for processing in the following steps and later application, especially as active material in lithium-ion battery anodes. Similarly, the method can allow for a wide range of precursor materials, as impurities may be removed during the process.

According to yet another embodiment, the binder contains at least one of starch, modified starch, phenolic resin, modified Kraft lignin, styrene-butadiene rubber (SBR), and latex. Preferably, the binder contains starch and/or modified starch or consists thereof. These materials may be widely available, cheap and, due to their composition, can be carbonized in the carbonization step described above. At the same time, the granulation step can be carried out under favorable conditions with these binders, preferably using water as a solvent. Yet, the invention does not depend on the particular choice of such binders. The binder preferably facilitates the agglomeration of fine carbonaceous powders, in particular to carbonaceous granules. Advantageously, each carbonaceous particle receives a binder coating. Preferably, the particles are bound together into granules through the binder. In this way, the carbonaceous granules may yield carbonized granules after the carbonization step that are preferably strong enough to pass through the electro-thermal fluidized bed reactor substantially without mechanical disintegration, but yet allow for a deagglomeration by mild mechanical treatment. Moreover, in this way, the individual carbon particles preferably retain an intact carbonized coating, in particular a hard carbon shell. Suitable binders for this purpose include, but are not limited to: binders containing starch, modified starch, phenolic resin, modified Kraft lignin, styrene-butadiene rubber (SBR), or latex.

Preferably, the binder is used in an amount of from 3 to 25 wt. %, more preferably from 5 to 20 wt. %, based on the total weight of the carbonaceous particles and the binder.

If a solvent, for example water, is used, the solvent is used in an amount of from 10 to 30 wt. %, more preferably from 15 to 25 wt. %, based on the total weight of the binder and the carbonaceous particles.

According to yet another embodiment, in the carbonization step, the carbonaceous granules are heated in a first heating step to a first temperature of from 30° C. to 700° C., preferably from 30° C. to 300° C., and then heated in a second heating step to a second temperature of from 300° C. to 1400° C., preferably from 300° C. to 1300° C., more preferably from 300° C. to 1100° C. The step may require a careful calcination, in line with prior art procedures in the preparation of graphitizable carbons, and for the optimal yield in the process and process properties. Both heating steps may be carried out batchwise or continuously, and in one or in separate furnaces with and without pretreatment of the granules.

According to yet another embodiment, the carbonaceous granules are heated to the first temperature for a period of from 0.1 to 20 hours, preferably of from 0.25 to 12 hours, and/or heated to the second temperature for a period of from 0.1 to 20 hours, preferably of from 0.25 to 12 hours. The carbonization time may depend on the oven that is used for heating. If a rotary kiln is used, the carbonaceous granules are advantageously heated to the first and/or second temperature for a period from 0.1 to 2 hours, preferably from 0.5 to 1.5 hours. If an oven such as a debindering or a sintering furnace is used, the carbonaceous granules are advantageously heated to the first and/or second temperature for a period from 5 to 20 hours, preferably from 10 to 15 hours, more preferably from 10 to 12 hours. Under these carbonization conditions, the resulting carbonized granules may show advantageous properties, especially in regard to the graphitizability in the following step. The carbonization steps can be conducted in directly and indirectly heated rotary kilns under reducing atmosphere with less than 2% vol of oxygen, or in a directly or indirectly heated oven chamber under reducing atmosphere with less than 2% vol of oxygen, or other suitable devices.

The graphitization step can be conducted batchwise or continuously, preferably continuously.

According to yet another embodiment, the carbonized granules are introduced into an electro-thermal fluidized bed reactor in the graphitization step. A suitable electrothermal fluidized bed reactor is described for example in U.S. Pat. No. 3,684,446 or U.S. Pat. No. 3,807,961. In such a reactor, the particles can be heated quickly and directly in local plasma conditions. Compared with other reactor types, and especially the Acheson process, an electro-thermal fluidized bed reactor can have advantages in one or more of energy consumption per unit of product, product homogeneity due to mixing during fluidization, also when considering boron content, continuous operation in contrast to batchwise operation, throughput and/or controllability of residence time.

According to another embodiment, the graphitization step is conducted at a temperature of at least 2000° C., preferably at least 2300° C., more preferably at least 2400° C., most preferably at least 2550° C. The aforementioned temperatures are in particular blackbody radiation temperatures. The graphitization step is preferably conducted at a temperature of at most 3500° C., more preferably at most 3200° C., most preferably at most 3000° C. If the graphitization step is conducted in the aforementioned temperature ranges, the formation of boron nitride may be reduced. According to yet another embodiment, the average residence time of the carbonized granules in the electrical field during the graphitization is from 5 to 120 minutes, preferably from 10 to 90 minutes, more preferably from 15 to 60 minutes, most preferably from 20 to 45 minutes. These specified average residence times can ensure high graphitization and purification, boron diffusion and homogeneous particle properties, while still enabling high throughput through the reactor.

According to yet another embodiment, the graphitized granules are cooled to a temperature of 500° C. or less after the graphitization step over a period of 5 to 90 minutes, preferably from 10 to 60 minutes, more preferably from 15 to 45 minutes, most preferably from 20 to 30 minutes. A fast cooldown is believed to prevent the formation of boron clusters, such as boron carbide, as well as loss of boron from the graphite lattice.

According to yet another embodiment, in the deagglomeration step, the particle-particle contacts of the carbon particles in the graphitized granules are crushed, advantageously by shearing forces. Preferably, in the deagglomeration step, the graphitized granules are deagglomerated using a mill, in particular a mill selected from a ball mill, a jet mill, a hammer mill, and a conical mill, preferably a jet mill. Deagglomeration of the granules yields particles in the preferred particle size distribution range for the following application, especially as active material in anodes for lithium-ion batteries. The crushing step length and mill choice may be adjusted depending on particle properties and application specifications. The aforementioned mills, in particular jet mills, are highly suitable for crushing the particle-particle contacts of the carbon particles.

According to yet another embodiment, the boron source is selected from boron oxide, boric acid, elemental boron, and mixtures thereof, preferably boron oxide. Advantageously, the boron source is added in the granulation step or in the graphitization step, preferably in the graphitization step, in particular as a separate powder for mixing and evaporating. The selection of the boron source and step of boron introduction may affect the obtained boron content in particle and/or shell, especially when comparing boron introduction in the binder formulation versus introduction into the fluidized bed. Furthermore, the reaction time to achieve the desired boron distribution can be affected.

According to yet another embodiment, the graphitization step is conducted in the presence of a nitrogen source, preferably in the presence of nitrogen. Nitrogen gas may serve as a process gas for fluidization and prevention of oxidation, but also as a source of nitrogen for doping. Argon may be used in place of nitrogen when nitrogen doping by the fluidization gas is not desired. In such a case, the nitrogen source can be added, for example, in the form of urea powder in graphitization step.

Another aspect of the present disclosure relates to the use of a carbon particle as described herein as the active material of a negative electrode for a battery, in particular for a lithium ion secondary battery. The anode may be fabricated from the active material or a mixture of active materials, by coating a current collector with a mixture of active material, binder, additives and, if necessary, solvent.

Another aspect of the present disclosure relates to a battery, in particular, a lithium ion secondary battery containing the carbon particle described herein, in particular as active material of a negative electrode.

The battery may be assembled from the as-described negative electrode and also include a cathode containing, among others, an active material able to intercalate and deintercalated lithium reversibly, including but not limited to lithium iron phosphate LiFePO₄, lithium cobalt oxide LiCoO₂, lithium nickel oxide LiNiO₂, lithium manganese oxide LiMn₂O₄, and related materials such as the so called NCM materials, LiNiₓMn_{y}Co_{z}O₂, with x+y+z=1, or spinel structures such as LiNi_{0.5}Mn_{1.5}O₄. Furthermore, the battery may contain a polymer or glass fiber separator and an electrolyte, consisting of one or more organic solvents and a lithium salt, including but not limited to lithium hexafluorophosphate LiPF₆, lithium perchlorate LiClo₄ or lithium tetrafluoroborate LiBF₄. The electrolyte may contain further additives, including but not limited to organic molecules like vinylene carbonate or fluoroethylene carbonate and/or salts like lithium difluorophosphate. The use and combination of electrolyte and additives may be chosen based on the anode and cathode active material properties. Examples

Different carbonaceous particles were granulated using an aqueous starch solution as a binder in a drum granulator. The amount of starch was 7 wt. %, based on the total weight of the carbonaceous particles and the starch binder.

The particle size distributions were determined by laser scattering Microtrac S3500 after dispersing under sonication in a Branson 3510 ultrasound bath using a Branson Sonifier 250-Ultrasonic Probe with a surfactant ‘Triton X100’.

The following carbonaceous particles were used:
Carbonaceous particle 1: Sponge coke 1, d₁₀: 1.7 μm; d₅₀: 8.7 μm; d₉₀: 23.2 μm, sulfur content 3.55% wt:
Carbonaceous particle 2: Sponge coke 11, d₁₀: 2.5 μm; ds0: 10.0 μm; d₉₀: 21.8 μm, sulfur content: 0.85% wt.
Carbonaceous particle 3: Needle coke 1, d₁₀: 6.5 μm; d₅₀: 19.0 m; d₉₀: 40.7 μm, sulfur content: 0.47% wt
Carbonaceous particle 4: Needle coke 11, d₁₀: 2.9 μm; d₅₀: 9.1 μm; d₉₀: 18.7 μm, sulfur content: 0.6% wt

The resulting carbonaceous granules of Sponge coke I+II were then heated to a temperature of 1100° C. for a total residence time of 45 min in a rotary kiln after a heat treatment to 300° C. in a rotary kiln with a total residence time of 45 min. Needle coke I+II were heat treated in a batch oven for a total batch time of 12 hours to a peak temperature of 1100° C. after being treated in another batch oven over 12 hours for a peak temperature of 650° C.

The resulting carbonized granules were cooled to room temperature and 150 kg of the carbonized granules was subsequently introduced into an electro-thermal fluidized bed (EFB) reactor as described in U.S. Pat. No. 3,684,446. The EFB reactor was operated at a temperature of 2400° C. to 2700° C. and contained nitrogen as inert gas. The carbonized granules had an average residence time in the EFB reactor of about 60 minutes and were converted to graphitized granules. Between 4.5 kg to 8.5 kg of dry boron oxide was added to the EFB reactor during the graphitization, depending on the intended boron doping. The graphitized granules were cooled to less than 500° C. upon exiting the EFB reactor over a period of about 60 minutes. The cooled graphitized granules were then introduced into a jet mill in which the granules were deagglomerated in a jet mill to yield the carbon particles.

The carbon particles had the following properties

TABLE 1
properties of the carbon particles

| | | | Substitutional | Boron | | | |
|---|---|---|---|---|---|---|---|
| Ex. | | Graphiticity | boron content | nitride | d₁₀ | d₅₀ | d₉₀ |
| No | Coke identifier | [%] | [% wt] | [% wt] | [μm] | [μm] | [μm] |
| 1 | Sponge coke I | 90.6 | 0.59 | 0.33 | 3.8 | 14.5 | 42.9 |
| 2 | Sponge coke I | 90.1 | 0.53 | 0.21 | 3.9 | 15.1 | 32.5 |
| 3 | Sponge coke I | 88.6 | 0.34 | 0.12 | 4.1 | 15.8 | 33.0 |
| 4 | Sponge coke I | 88.5 | 0.38 | 0.07 | 3.5 | 14.7 | 32.8 |
| 5 | Sponge coke II | 93.7 | 0.54 | 0.19 | 5.8 | 14.7 | 32.2 |
| 6 | Needle coke I | 94.8 | 0.61 | n/d | 9.7 | 22.5 | 40.4 |
| 7 | Needle coke II | 96.0 | 0.34 | 0.04 | 6.3 | 13.2 | 23.0 |

Ex. No = Example number
n/d = not determined

The Graphiticity is determined using the following formula:

$$Graphiticity = ( 0.344 nm - {d}_{002} ) / ( 0.344 nm - 0.3354 nm )$$

d₀₀₂ is the distance between two adjacent layers in graphite as determined by X-ray.

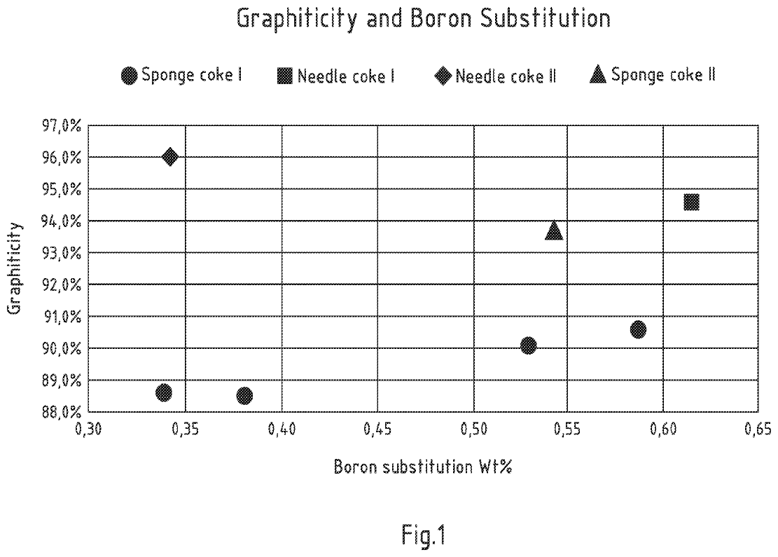

FIG. 1 shows the connection between boron substitution and graphiticity.

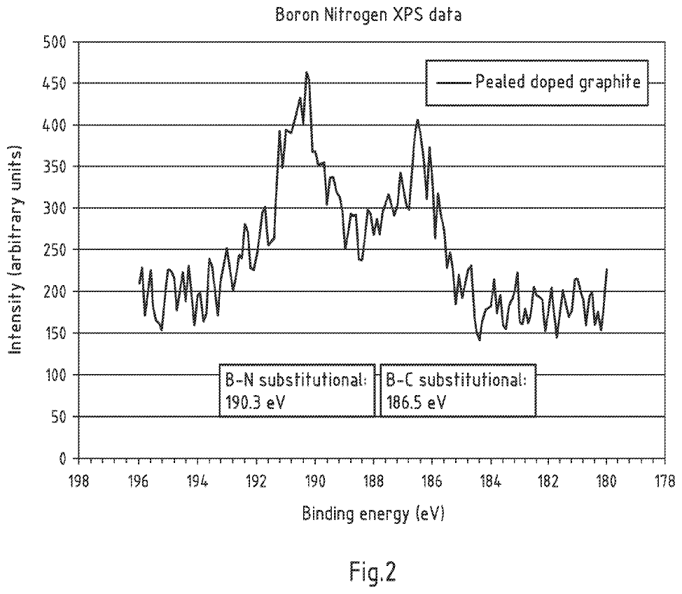

FIG. 2 shows the XPS peaks for the B-C (186.5 eV) and B-N (190.3 eV) bonds and the absence of the B-B bonds of a carbon particle sample prepared from natural flake graphite treated in the EFB furnace under dosage of boron oxide and under nitrogen atmosphere at a black body radiation temperature of 2300° C. and after removal of the boron nitride from the surface by peeling using a tape. The residence and cooling times of this flake graphite sample as well as the deagglomeration conditions were as for Examples 1-6 described above. The peak ratio of the peak at 190.3 eV to 186.5 eV is approximately 1.1. According to the XPS measurements, the carbon particles contain boron nitride. Further, the absence of a peak for boron-boron bonds shows that there is substantially no boron present in boron clusters.

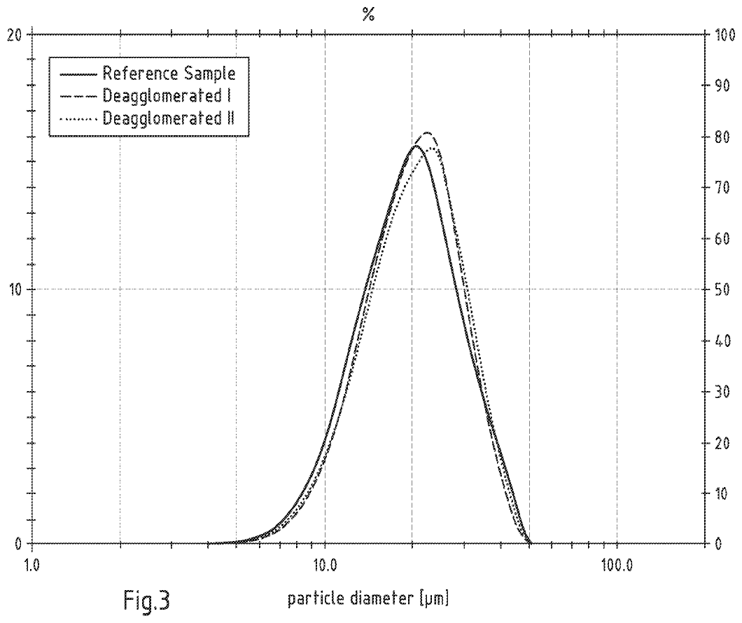

FIG. 3 shows volumetric particle size distributions of a reference sample and the deagglomerated carbon particles of spherical natural flake graphite powder that was agglomerated and treated using the carbonization and EFB heat treatment process described above, followed by deagglomeration, and hence shows the recovery of the particle size distributions during the deagglomeration step. The deagglomeration was done by an air jet mill.

Table 2 gives metallic impurity, oxygen and sulfur levels of de-agglomerated samples.

TABLE 2
purity of carbon particles

| | Needle coke I | Needle Coke II | Sponge coke II |
|---|---|---|---|
| Example # | 6 | 7 | 5 |
| Oxygen % | 0.008 | 0.006 | 0.007 |
| Sulfur % | <0.005 | <0.005 | <0.005 |
| Element | ppm | ppm | ppm |
| Co | <0.6 | <0.6 | <0.6 |
| Ni | <0.6 | <0.6 | <0.6 |
| Si | 1.1 | 1.0 | 1.8 |
| Mn | <0.6 | <0.6 | <0.6 |
| Fe | 0.66 | 3.1 | 2.2 |
| Mo | <0.6 | <0.6 | <0.6 |
| Cr | <0.6 | <0.6 | <0.6 |
| V | 2.9 | 9.3 | 24.9 |
| Cu | <0.6 | 0.7 | <0.6 |
| Al | <0.6 | <0.6 | 0.9 |

Further, the carbon particles for all Examples exhibited less than 0.2 wt. % impurities including the metals listed above as well as oxygen and sulfur, based on the total weight of the carbon particles. Moreover, the carbon particles for all Examples exhibited less than 0.05 wt. % boron carbide, based on the total weight of the carbon particles.

The carbon particles also contained at least 97 wt. % carbon, based on the total weight of the carbon particles.

The amounts of impurities (oxygen) were determined using a Leco ONH836 gas analyzer.

The amounts of impurities (sulfur) were determined using a LECO SC-432 sulfur determination unit.

The amounts of impurities (metallic nature, see above) were determined using a Jobin Yvon Horiba Ultima 2 1CP-OES.

The amounts of boron nitride were determined by treating the carbon particle by leaching with caustic (NaOH_{aq}) up to 250° C. in a Anton Paar Multiwave 7000 Microwave digester and analyzing the residue of the caustic treatment using 1CP-OES on the boron. The amount of boron was determined by the following steps: firstly ashing 3 g of sample in a Muffle furnace at 780-800° C. for eight hours in air, secondly, leaching the boron oxide from the ash in hot 2% nitric acid followed by the filtration of boron nitride in the ash to obtain a nitric acid filtrate, thirdly, determining the boron content in the nitric acid filtrate using ICP-OES.

The amount of boron carbide was determined using the visual inspection method as described hereinabove.

Below, to illustrate the viability of the particles described here, initial results of electrochemical testing. The capacity and first cycle loss were obtained from the powder by preparing the anode slurry as such: PVDF 9300 Kureha: 5-7%, Carbon black: Super C65 Imerys: 2%, NMP: Alpha, Graphite: 91-93%. The anode was inserted in 2032 coin half-cells. The testing of the half cells was done on an Arbin 24-channel cycler with the following sequence: 2 cycles C/20, 2 cycles C/5 followed by constant voltage at 5 mV until <10% of the initial current. The capacity and first cycle loss represent an average of five cells.

| Ex. | Coke | | Capacity | 1^{st} cycle |
|---|---|---|---|---|
| No | identifier | BET [m²/g] | mAh/g | loss [%] |
| 6 | Needle coke | 1.5 | 342 | 8.5 |
| | I | | | |
| 6 | Needle coke | 1.5 | 347 | 8.3 |
| | I (re-test) | | | |
| 7 | Needle coke | 2.1 | 351 | 8.8 |
| | II | | | |
| 5 | Sponge II | 2.1 | 342 | 8.4 |

1. A carbon particle comprising:
at least 97 wt. % carbon, based on the total weight of the carbon particle,
at most 0.2 wt. % impurities, based on the total weight of the carbon particle,
at least 0.08 wt. % boron, based on the total weight of the carbon particle,
at most 0.05 wt. % boron carbide, based on the total weight of the carbon particle, and at most 0.5 wt. % boron nitride, based on the total weight of the carbon particle.

2. The carbon particle according to claim 1, wherein the carbon particle has a BET surface area of from 0.5 to 50 m2/g, and/or
wherein the carbon particle has a d₀₀₂ spacing of from 0.3363 nm to 0.3355 nm, and/or
a d₁₁₀ spacing of from 0.120 nm to 0.126 nm.

3. The carbon particle according to claim 1, wherein an XPS spectrum of the carbon particle has a first peak at from 184.0 eV to 188.0 eV, and/or
wherein an XPS spectrum of the carbon particle has a second peak at from 188.5 eV to 192.0 eV, and/or
wherein an XPS spectrum of the carbon particle has substantially no peak at about 187.7 eV, wherein in particular the intensity ratio in the XPS spectrum of the first peak to the second peak is from 0.25 to 6.0.

4. The carbon particle according to claim 1, wherein the carbon particle contains at least 97.5 wt. carbon, based on the total weight of the particle, and/or
at most 0.1 wt. % impurities, based on the total weight of the carbon particle.

5. The carbon particle according to claim 4, wherein the impurities are at least one of vanadium, iron, oxygen, or sulfur, and optionally at most 100 ppm oxygen and 100 ppm sulfur.

6. The carbon particle according to claim 1, wherein the carbon particle contains at least 0.1 wt. % to 2.3 wt. % boron in a substitutional position, based on the total weight of the carbon particle.

7. The carbon particle according to claim 1, wherein the carbon particle contains nitrogen in an amount of at least 0.005 wt. % to 0.03 wt. % based on the total weight of the carbon particle.

8. The carbon particle according to claim 1, wherein the carbon particle contains at most 0.03 wt. % boron carbide, based on the total weight of the carbon particle, and/or wherein the carbon particle contains, at most 0.3 wt. % boron nitride based on the total weight of the carbon particle.

9. The carbon particle according to claim 1, wherein the carbon particle has a particle size distribution d₅₀ from 2 to 30 μm, and/or a particle size distribution d₉₀ from 6 to 50 μm.

10. The carbon particle according to claim 1, wherein the carbon particle is a core-shell particle comprising a substantially non-graphitizable, hard carbon shell, and a carbon core that is at least partially graphitized and optionally soft carbon parts.

11. The carbon particle according to claim 10, wherein the core comprises from 91 wt. % to 99 wt. % of the total weight of the carbon particle, and the shell comprises from 1 wt. % to 9 wt. % of the total weight of the carbon particle.

12. The method for the preparation of a carbon particle according to claim 1, wherein in a granulation step, carbonaceous particles are granulated using a binder to yield carbonaceous granules, in a carbonization step, the carbonaceous granules are heated to a temperature of at least 1000° C. to yield carbonized granules, in a graphitization step, the carbonized granules are introduced into an electrical field to effect the graphitization of the carbonized granules thereby yielding graphitized granules, and in a deagglomeration step, the graphitized granules are deagglomerated thereby yielding the carbon particles, wherein at least one of the granulation step, the carbonization step, and the graphitization step are conducted in the presence of a boron source.

13. The method according to claim 12, wherein the carbonaceous particles have a particle size distribution d₅₀ from 2 to 30 μm, and/or a particle size distribution d₉₀ from 6 to 50 μm, and/or wherein the carbonaceous particles are selected from green petcoke particles, calcined petcoke particles, spherical flake graphite particles, spherical natural graphite particles, recycled anode powder particles, petroleum coke, pitch coke, carbonized wood, needle coke, sponge coke, metallurgical coke, coal tar based carbons, mesocarbons, anthracite, synthetic graphite, natural graphite, expanded graphite, carbonized polymers, carbon black, and mixtures thereof, preferably selected from green petcoke particles, calcined petcoke particles, spherical flake graphite particles, spherical natural graphite particles, recycled anode powder particles, and mixtures thereof.

14. The method according to claim 12, wherein the binder contains at least one of starch, modified starch, phenolic resin, modified Kraft lignin, styrene-butadiene rubber (SBR), latex, and combinations thereof.

15. The method according to claim 12, wherein in the carbonization step, the carbonaceous granules are heated in a first heating step to a first temperature of from 30° C. to 1100° C.

16. The method according to claim 15, wherein the carbonaceous granules are heated to the first temperature for a period of from 0.1 to 20 hours.

17. The method according to claim 12, wherein the carbonized granules are introduced into an electro-thermal fluidized bed reactor in the graphitization step, and/or wherein the average residence time of the carbonized granules in the electrical field during the graphitization is from 5 to 120 minutes and/or wherein the graphitized granules are cooled to a temperature of 500° C. or less after the graphitization step over a period of 5 to 90 minutes, and/or wherein in the deagglomeration step, the graphitized granules are deagglomerated using a mill, in particular a mill selected from a ball mill, a jet mill, a hammer mill, and a conical mill.

18. The method according to claim 12, wherein the boron source is selected from boron oxide, boric acid, elemental boron, and mixtures thereof, and/or wherein the boron source is added in the granulation step or in the graphitization step as a separate powder for mixing and evaporating, and/or wherein the graphitization step is conducted in the presence of a nitrogen source.

19. Use of a carbon particle according to claim 1 as the active material of a negative electrode for a battery and/or a lithium ion secondary battery.

20. The battery according to claim 19, wherein the carbon particle is an active material of a negative electrode in the lithium ion secondary battery.
